(19) United States
(12) Patent Application Publication
(10) Pub. No.: US 2011/0145852 A1
(43) Pub. Date: Jun. 16, 2011

(54) APPARATUS FOR CONTROLLING INTERNET PROTOCOL TELEVISION SERVICES AND METHOD FOR PROVIDING INTERNET PROTOCOL TELEVISION SERVICES USING THE SAME

(75) Inventors: Hyun-Jin LEE, Daejeon-si (KR); Kee-Seong CHO, Daejeon-si (KR)

(73) Assignee: Electronics and Telecommunications Research Institute, Daejeon-si (KR)

(21) Appl. No.: 12/900,552

(22) Filed: Oct. 8, 2010

(30) Foreign Application Priority Data
Dec. 10, 2009 (KR) 10-2009-0122647

(51) Int. Cl. H04N 7/16

(52) U.S. Cl. 725/25

(57) ABSTRACT

An apparatus and method for controlling Internet Protocol television (IPTV) service is provided. The IPTV service controlling apparatus includes a service control unit and a display information providing unit. The service control unit is configured to conduct a user authentication based on user information of an Internet Protocol television (IPTV) terminal, create Electric Program Guide (EPG) information according to a request for EGP information made by an authorized user, transport the created EPG information to the display information providing unit and provide the IPTV terminal with an IPTV service that is requested using the EPG information by the user. The display information providing unit processes the EPG information to correspond to an environment of the IPTV terminal based on information about the IPTV terminal and provides the IPTV terminal with the processed EPG information.

### CROSS-REFERENCE TO RELATED APPLICATION

This application claims the benefit under 35 U.S.C. §119(a) of Korean Patent Application No. 10-2009-0122647, filed on Dec. 10, 2009, the disclosure of which is incorporated by reference in its entirety for all purposes.

### BACKGROUND

1. Field

The following description relates to a broadcast service, and more particularly, to an apparatus for controlling an Internet Protocol television (IPTV) service and a method of is providing an IPTV service using the same.

2. Description of the Related Art

An Internet Protocol television (IPTV) service is to provide information service, a moving picture content and a broadcast service over a television using the internet. IPTV is one type of digital convergence technology and implemented by using a television monitor and a remote control instead of a computer monitor and a mouse, respectively.

A user watches contents through the IPTV by accessing a Set-Top Box (STB) or a dedicated modem and then turning on the IPTV, as if turning on a general television. Accordingly, by using a remote control, even a user who is not accustomed to a computer can browse the internet and enjoy various contents and supplementary services provided by a website, such as movie appreciation, home shopping, home banking, on-line game, MP3, etc.

Such an IPTV is similar to a conventional cable broadcasting or satellite broadcasting in that it provides broadcast contents including video contents, but different from Air broadcasting, cable broadcasting or satellite broadcasting in that it further provides interactivity and allows users to watch a program at their convenience when they want.

However, there is an inconvenience that a user authentication is gained through a set-top box in subscribing an IPTV service, so each user needs to have his/her own set-top box in use of the IPTV services. In order to relieve this inconvenience, a method of gaining the user authentication using any other set-top box without using a user possessed set-top box has been suggested, but this method still has the need for a set-top box.

In addition, when a plurality of users make a request for Network Personal Video Recorder (NPVR) service, the recording is achieved at each storage space assigned for each user. However, in providing such an NPVR service, if the users each make a request for recording a content at the same time, the efficiency in use of the storage spaces and recording is lowered. Accordingly, the need for efficiently providing IPTV services arises.

### SUMMARY

In one aspect, there is provided an apparatus for controlling IPTV services and a method for providing IPTV services using the same, capable of gaining a user authentication without using a set top box in use of IPTV services and providing effectively IPTV services by performing a user authentication based on user information of an IPTV terminal, processing Electronic Program Guide (EPG) information to be optimized for an environment of an IPTV terminal of an authorized user and transmitting the optimized EPG information to the IPTV terminal of the corresponding user.

When a request for a content is made through EPG information, a recorded content is provided based on information about a time at which a request for recording the content is made by a user, thereby preventing overload and inefficient use of storage space caused when a plurality of users make a request for recording a content at the same time, and also enabling efficient use of storage space and efficient offering of IPTV services.

The efficiency and reliability in providing contents to an authorized user are enhanced through the control of a multimedia session connection between the IPTV terminal and a media providing unit for providing contents. In addition, an external user is capable of using various kinds of IPTV services including at least one of user authentication, EPG creation, request for IPTV service, session setting, request for recording, request for profile and change in EPG information through a web service gateway by downloading an application desired by a user.

In one general aspect, there is provided an apparatus for controlling Internet Protocol television (IPTV) service. The IPTV service controlling apparatus includes a service control unit and a display information providing unit. The service control unit is configured to conduct a user authentication based on user information of an Internet Protocol television (IPTV) terminal, create Electric Program Guide (EPG) information according to a request for EGP information made by an authorized user, transport the created EPG information to the display information providing unit and provide the IPTV terminal with an IPTV service that is requested using the EPG information by the user. The display information providing unit processes the EPG information to correspond to an environment of the IPTV terminal based on information about the IPTV terminal and provides the IPTV terminal with the processed EPG information.

In another general aspect, there is provided a method of providing an Internet Protocol Television (IPTV) service. The method is as follows. At an authentication unit, a user authentication is conducted based on user information of an Internet Protocol Television Service (IPTV) terminal. At an Electric Program Guide (EPG) information creation unit, EPG information is created based on a user specific content access right that is included in a user profile. At a display information providing unit, the EPG information is processed to correspond to an environment of the IPTV terminal based on information about the IPTV terminal and providing the IPTV terminal with the processed EPG information. At a media providing unit, if a request for a content is made by a user using the EPG information, a recorded content is provided to the IPTV terminal based on information about time at which the request for recording the content is made by the user.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an example of an IPTV service controlling system.

FIG. 2 is a flowchart illustrating an example of an IPTV service providing method. is FIG. 3 is a flowchart illustrating an example of an IPTV service providing method by use of a call control unit.

FIG. 4 is a diagram illustrating another example of an IPTV service controlling system including a web service gateway.

FIGS. 5A and 5B are flowcharts illustrating another example of an IPTV service providing method.

FIGS. 6A and 6B are flowcharts illustrating an example of a method of providing a Network Personal Video Recorder (NPVR) service.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings in detail.

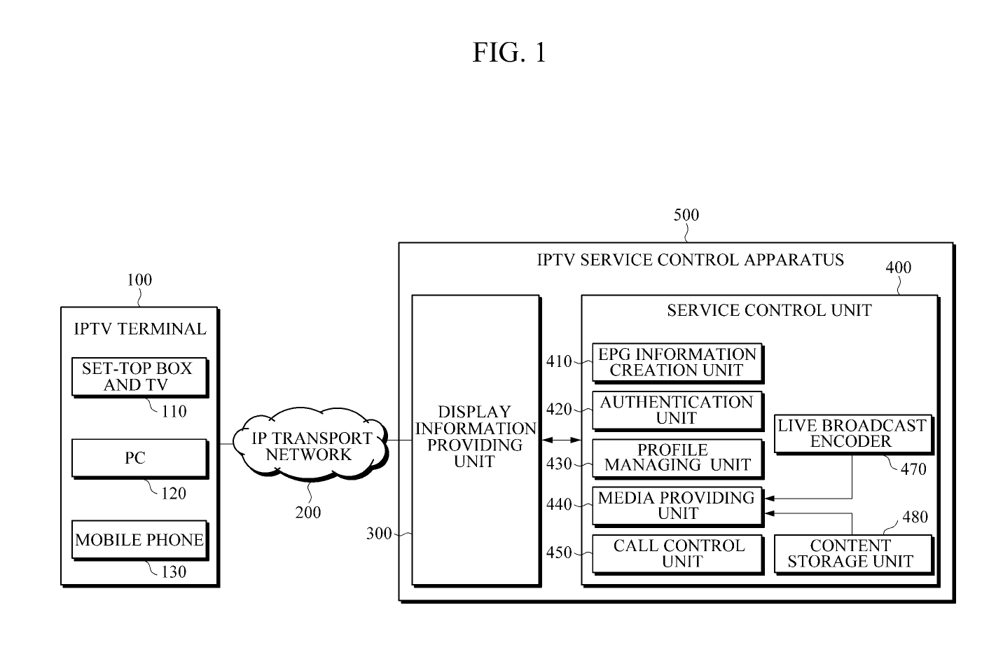

FIG. 1 is a diagram illustrating an example of an IPTV service controlling system.

According to the example of the IPTV service controlling system, a user may receive an Internet Protocol Television (IPTV) service through various types of IPTV terminals, such as a personal computer and a mobile terminal in addition to a set-top box. The IPTV service includes various types of services related to a channel broadcasting service, a Video on Demand is (VoD), favorites and a recording function that are purchased by a user.

In addition, in providing a Network Personal Video Recorder (NPVR) service, a prerecorded broadcast is provided using encoded contents, a live broadcast is provided by encoding the live broadcast in real time while storing information about a recording time, at which a user makes a request for recording, in a common storage space without assigning a storage space for each user. In this manner, the IPTV service controlling system saves on storage space.

As shown in FIG. 1, an example of an IPTV service controlling system includes an IPTV terminal 100 and an IPTV service controlling apparatus 500. The IPTV terminal 100 may include wired/wireless terminals such as a set-top box and television 110, a personal computer (PC) 120 and a mobile terminal 130 that are available for access to an IP transport network 200.

The IPTV service controlling apparatus 500 includes a display information providing unit 300 and a service control unit 400. The display information providing unit 300 processes Electric Program Guide (EPG) information to correspond to an environment of the IPTV terminal 100 based on information about the IPTV terminal 100, and provides the IPTV terminal 100 with the processed EPG information.

For example, the display information providing unit 300 processes EPG information to correspond to a screen size and a resolution of the IPTV terminal 100, and provides the IPTV terminal 100 with the processed EPG information. In addition, the information about the IPTV terminal 100 may include information about a model name, a screen size, pixels and power handling capacity of the IPVT terminal 100. The information about the IPTV terminal 100 may be included in an IPTV terminal profile and stored in a profile managing unit 430 which is to be described later.

The service control unit 400 includes an EPG information creating unit 410, an authentication unit 420, a profile managing unit 430, a media providing unit 440, a call control unit 450, a live broadcast encoder 470 and a content storage unit 480. The EPG information creation unit 410, the authentication unit 420, the profile managing unit 480, the media providing unit 440, the call control unit 450 and the content storage unit 480 may be implemented as individual servers associated with each other.

First, the EPG information creation unit 410 creates EPG information. The authentication unit 420 performs a user authentication based on user information of the IPTV terminal 100. In this case, the EPG information creation unit 410 may create the EPG information based on a user specific content access right that is included in a user profile.

The profile managing unit 430 stores a user profile, an IPTV terminal profile and a content profile. The user profile may include information about a content access authority that is granted to a user and the personal profile. The IPTV terminal profile may include information about a model name, a screen size, the type, the efficiency and the power handling capacity of the IPTV terminal 100. In addition, the content profile may include information about the type, the capacity, the name, a copyright and a license.

The live broadcast encoder 470 encodes a live broadcast being received, in real time. The content storage unit 480 stores encoded contents. The content storage unit 480 may store information about a time at which a request for recording a content is made by a user. The media providing unit 440 sends a user a media stream which is input from the live broadcast encoder 470 and the content storage unit 480, in a unicast mode or a multicast mode.

If a request for a content is made, the media providing unit 440 provides the IPTV terminal 100 with a recorded content based on information about a time at which a request for recording the content is made. In addition, the call control unit 450 controls a multimedia session connection and performs a message sending/receiving regarding a session setting between the IPTV terminal 100 and the media providing unit 440.

Meanwhile, an EGP creation request message, an authentication request message and a profile request message that are sent from the display information providing unit 300 to the service control unit 400 have the same format as those of reply messages sent from the service control unit 400 to the display information providing unit 300.

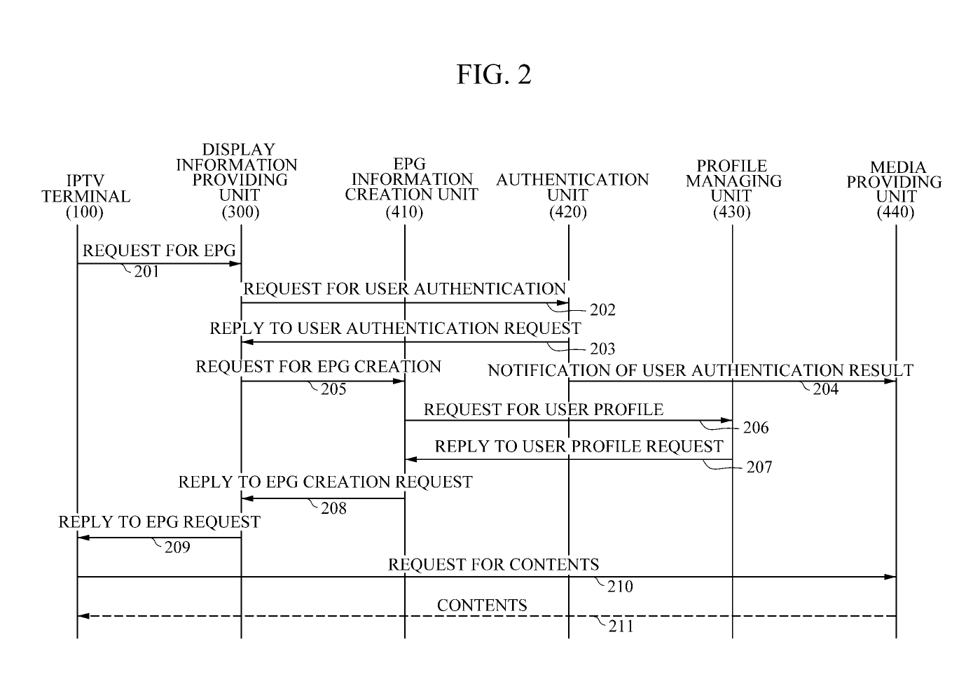

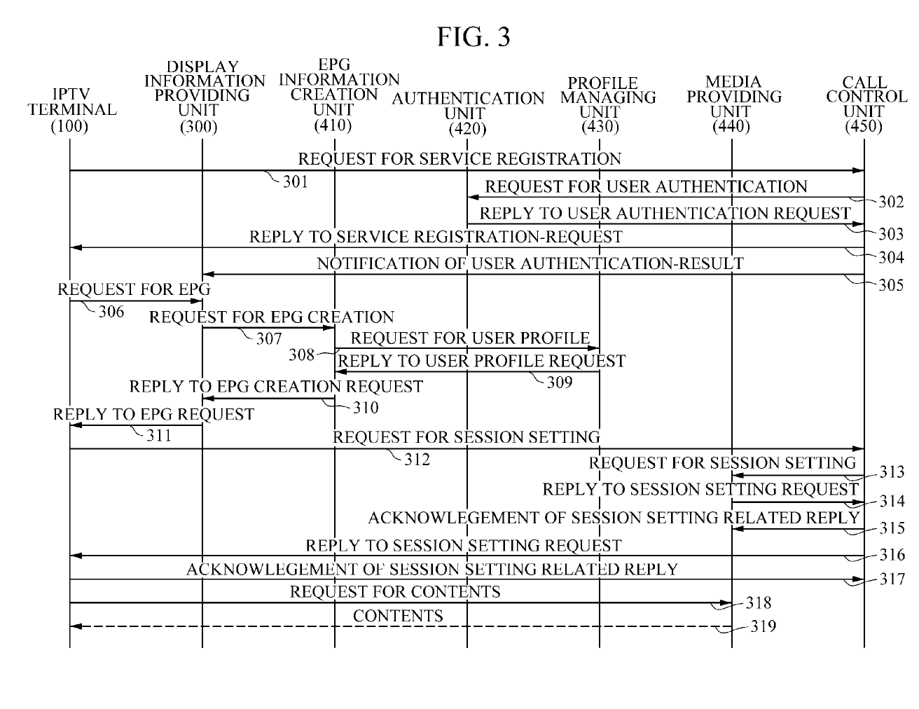

For example, a message sending/receiving between the display information providing unit 300 and the service control unit 400 may be achieved through XML schema. In this case, the display information providing 300 may process the EPG information to correspond to the environment of the IPTV terminal 100 by use of the information about the IPTV terminal 100 that is included in XML type data. Hereinafter, a process of providing an IPTV service by use of the IPTV service control system will be described in detail with reference to FIG. 2.

FIG. 2 is a flowchart illustrating an example of an IPTV service providing method.

The IPTV terminal 100 requests the display information providing unit 300 to provide EPG information (201). The display information providing unit 300 sends a request for user authentication to the authentication unit 420 (202). If the display information providing unit 300 receives a reply to the request, achieving the user authentication (203), the display information providing unit 300 sends a request for creating EPG information to the EPG information creation unit 410 (205). The authentication unit 420 notifies a result of the user authentication to the media providing unit 440 (204) such that the media providing unit 440 accepts a request for contents by an authorized user.

With regard to the authorized user, the EPG information creation unit 410 requests the profile managing unit 430 to provide a user profile (206) and receives the user profile (207). Through this process, the EPG information creation unit 410 creates personalized EPG information to which a user specific content access right is applied and replies to an EPG creation request that is made by the display information providing unit 300 (208). The details of EPG information may vary depending on the user specific access right.

The EPG information creation unit 410 may create the same EPG information regardless of a user profile and transport the same EPG information to all users. In addition, the EPG information unit 410 may receive an IPTV terminal profile including information about the IPTV terminal 100 from the profile managing unit 430 and sends the IPTV terminal profile in the EPG information to the display information providing unit 300.

After that, the display information providing unit 300 processes the EPG information to be optimized for the environment of the IPTV terminal 100 based on the information about the IPTV terminal 100, that is, the IPTV terminal profile, and provides the optimized EPG information to the IPTV terminal 100 (209). In more detail, when a message sending/receiving between the display information providing unit 300 and the service control unit 400 is performed through an XML schema, the display information providing unit 300 extracts information about the IPTV terminal 100 from data information received from the EPG information creation unit 410 and processes the EPG information to correspond to the environment of the IPTV terminal 100.

The display information providing unit 300 may directly extract information about the IPTV terminal profile from the profile managing unit 430 or may indirectly receive information about the IPTV terminal profile through the EPG information creation unit 410.

After that, the IPTV terminal 100 sends a request for content to the media providing unit 440 by use of the EPG information (210), and the media providing unit 440 transports the corresponding content to the IPTV terminal 100 in response to the request (211).

FIG. 3 is a flowchart illustrating an example of an IPTV service providing method by use of a call control unit.

The service control unit 400 and the IPTV terminal 100 may be mounted with a protocol for controlling a session, such as a Session Initiation Protocol (SIP). In this case, if the IPTV terminal 100 sends a request for service registration to the call control unit 450 (301), the call control unit 450 conducts a user authentication based on user information of the IPTV terminal 100 in cooperation with the authentication unit 420 (302 and 303). The request for service registration, which is used to use IPTV services, may be automatically performed when the IPTV terminal 100 is turned on.

If the authentication is achieved, the call control unit 450 sends a reply to the request for service registration to the IPTV terminal 100 (304). The call control unit 450 sends a result of the user authentication to the display information providing unit 300 such that the display information providing unit 300 receives EPG information for an authorized user. Operations (306 to 311) of processing an EPG request and a reply to the request are identical to those of 301, and 305 to 309, in FIG. 3.

After that, the IPTV terminal 100 sends a request for multimedia session setting to the call control unit 450, and a session setting procedure between the media providing unit 440 and the call control unit 450 is performed (312 to 317). The operations 312 to 317 are to reserve or set network resources for a content watching, for example, available bandwidth between the IPTV terminal 100 and the media providing unit 440.

In more detail, the call control unit 450 sends a request for session setting to the media providing unit 440 (330) and receives a reply to the session setting request from the media providing unit 440 (314). The call control unit 450 sends a session setting related acknowledge message to the media providing unit 440 (315) and sends a reply to the session setting request to the IPTV terminal 100 (316). The IPTV terminal 100 sends a session setting related acknowledge message to the call control unit 450.

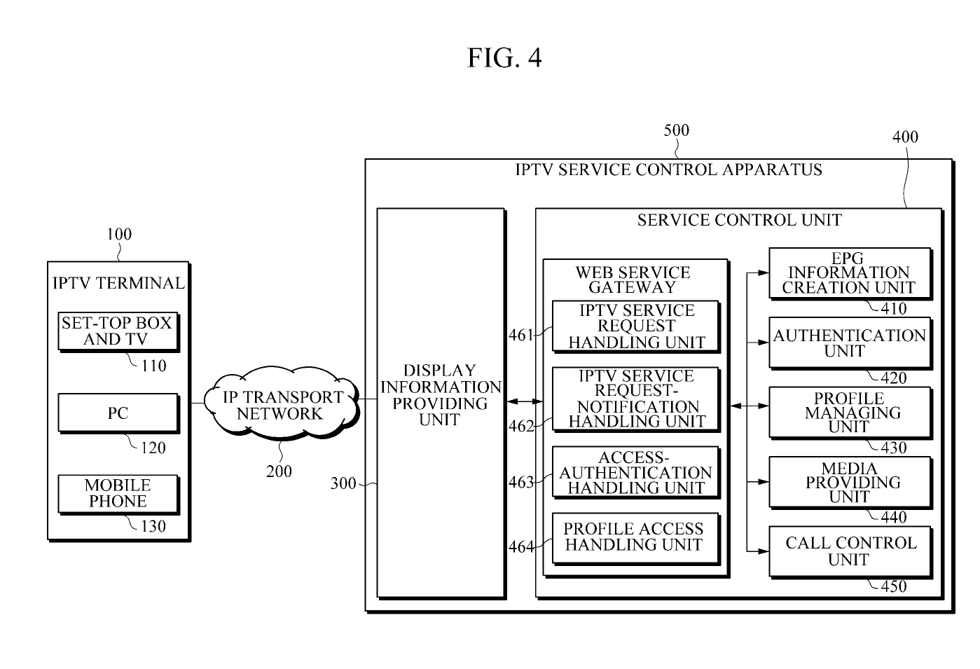

As the session setting is completed, the IPTV terminal 100 sends a request for contents to the media providing unit 440 (318) and the media providing unit 440 transports the corresponding content to the IPTV terminal 100 in response to the request (319). Hereinafter, another example of an IPTV service controlling system including a web service gateway will be described with reference to FIG. 4.

FIG. 4 is a diagram illustrating another example of an IPTV service controlling system including a web service gateway.

As shown in FIG. 4, the service control unit 400 further includes a web service gateway 460. The web service gateway 460 is associated with respective components 410, 420, 430, 440 and 450 of the service control unit 400 for providing IPTV services to perform mediation in providing IPTV services. In detail, the web service gateway 460 is associated with the service control unit 400 to mediate at least one operation of a user identification, an EGP information creation, a request for IPTV services, a session setting, a request for recording, a request for a profile and a change of EPG information.

To this end, the web service gateway 460 includes an IPTV service request handling unit 461, an IPTV service request-notification handling unit 462, an authentication access handling unit 463 and a profile access handling unit 464. An external user may use the IPTV service according to the present invention through the web service gateway 460. In addition, an application used to use IPTV services may be installed on a terminal of the external user.

The IPTV service request handling unit 461 receives various types of service request such as for a channel broadcast, a Video on Demand (VoD), a Network Personal Video Recorder (NPVR), an EPG creation, and a session setting, and enables the corresponding request to be handled through the service control unit 400.

The IPTV service request-notification handling unit 462 notifies the IPTV terminal 100 of a result for the IPTV service request made by a user, a change of EPG information or a change of status information of IPTV services. The authentication access processing unit 463 receives user information of the IPTV terminal 100 and allows authentication to be performed through the authentication unit 420.

The profile access handling unit 464 enables access to profile information or retrieval for profile information through the profile managing unit 430. As described above, respective components 461 to 464 of the web service gateway 460 provides IPTV services in association with the display information providing unit 300 and respective components 410, 420, 430, 440 and 450 of the service control unit 400.

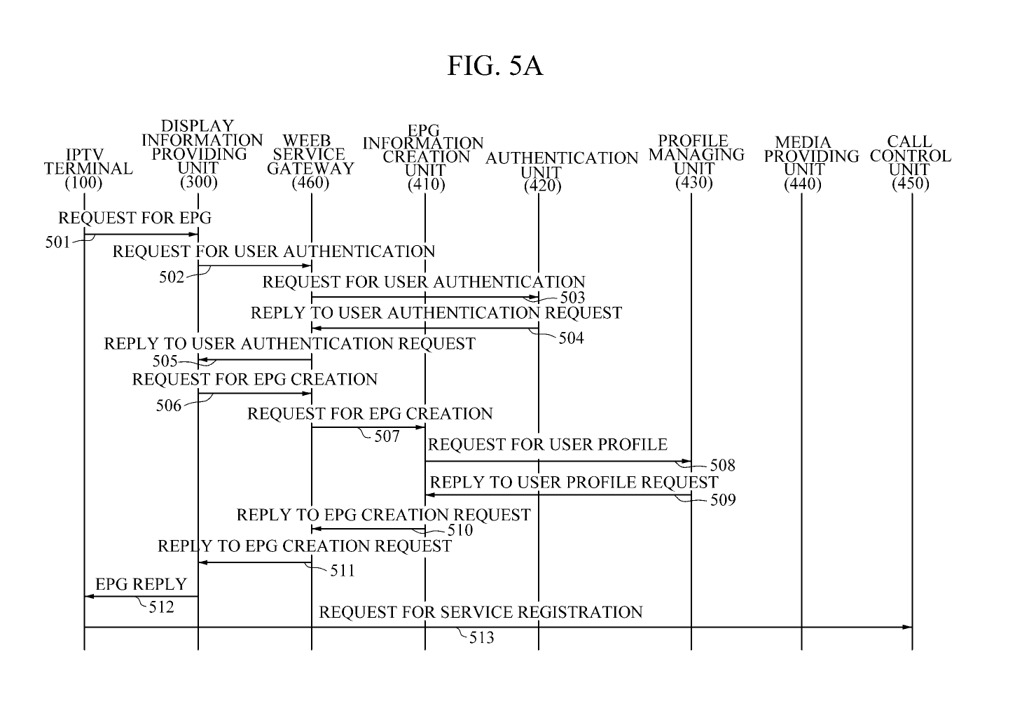

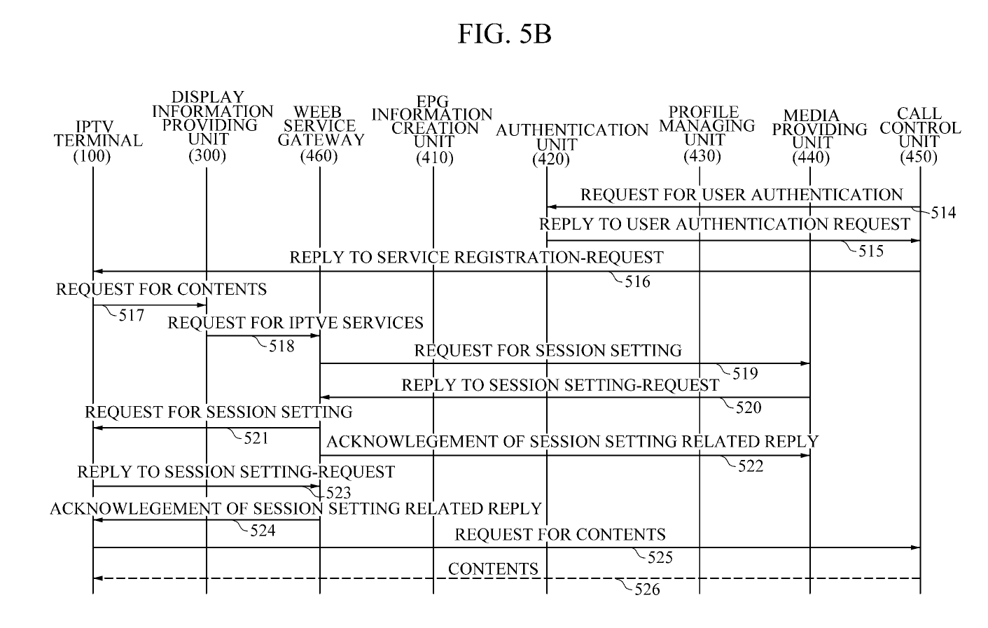

FIGS. 5A and 5B are flowcharts illustrating another example of an IPTV service providing method.

As shown in FIGS. 5A and 5B, IPTV services may be provided through the web service gateway 460 and the call control unit 450 for controlling a multimedia session. The web service gateway 460 performs data transmission/reception and serves as a gateway for authentication and EPG requesting in association the display information providing unit 300.

The IPTV terminal 100 sends a request for EPG information to the display information providing unit 300 (501). The display information providing unit 300 sends a request message for a user authentication to the authentication unit 420 through the web service gateway 460, and receives a reply to the request through the web service gateway 460 (503 to 505).

Then, the display information providing unit 300 sends a request message for EPG creation to the EPG information creation unit 410 through the web service gateway 460 (506 and 507). After that, in the case of an authorized user, the EPG information creation unit 410 sends a request for a user profile to the profile managing unit 430 (508) and receives the user profile (509).

The EPG information creation unit 410 creates personalized EPG, to which a user specific content access right is applied, and sends the created EPG as a reply to the EPG creation request of the display information providing unit 300, through the web service gateway 460 (510 and 511).

After that, the display information providing unit 300 processes the EPG to be suitable for characteristics of the IPTV terminal 100 and replies to the IPTV terminal 100 with the processed EPG (512). If the IPTV terminal 100 sends the call control unit 450 a request for service registration (513), the call control unit 450 sends the authentication unit 420 a request for user authentication (514), then the authentication unit 420 sends the call control unit 450 a reply message to the request for user authentication (515). The call control unit 450 sends the IPTV terminal 100 (516) a reply message to the service registration request.

After that, if the IPTV terminal 100 sends the display information providing unit 300 a request for contents (517), the display information providing unit 300 sends the web service gateway 460 a request for IPTV services (518). The web service gateway 460 sends the media providing unit 440 a request for session setting (519).

The media providing unit 440 sends the web service gateway 460 a reply to the session setting request (520), and the web service gateway 460 sends the IPTV terminal 100 a request for session setting (521). The web service gateway 460 sends the media providing unit 440 a session setting related reply-acknowledge message (522).

After that, the IPTV terminal 100 sends the web service gateway 460 a reply to the session setting request (523), and the web service gateway 460 sends the IPTV terminal 100 a session setting related acknowledge message (524). After that, the IPTV terminal 100 sends the media providing unit 440 a request for contents (525) and receives the corresponding contents in response to the request (526).

As described above, the web service gateway 460 mediates the session setting between the IPTV terminal 100 and the media providing unit 440. In the session setting processes (519 to 524), the messages for session setting are transmitted through the call control unit 450.

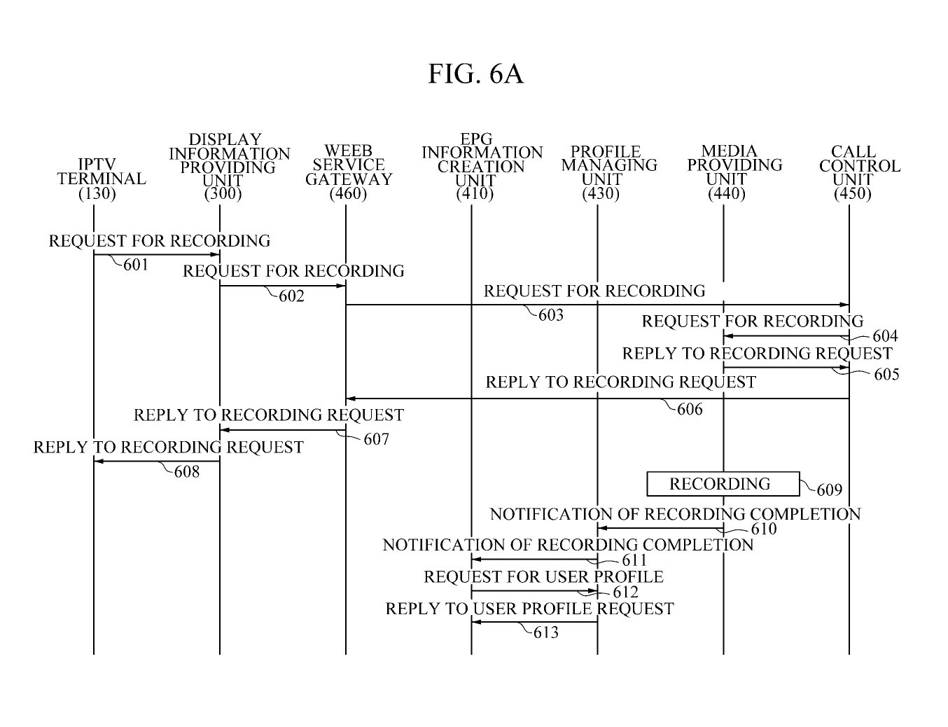

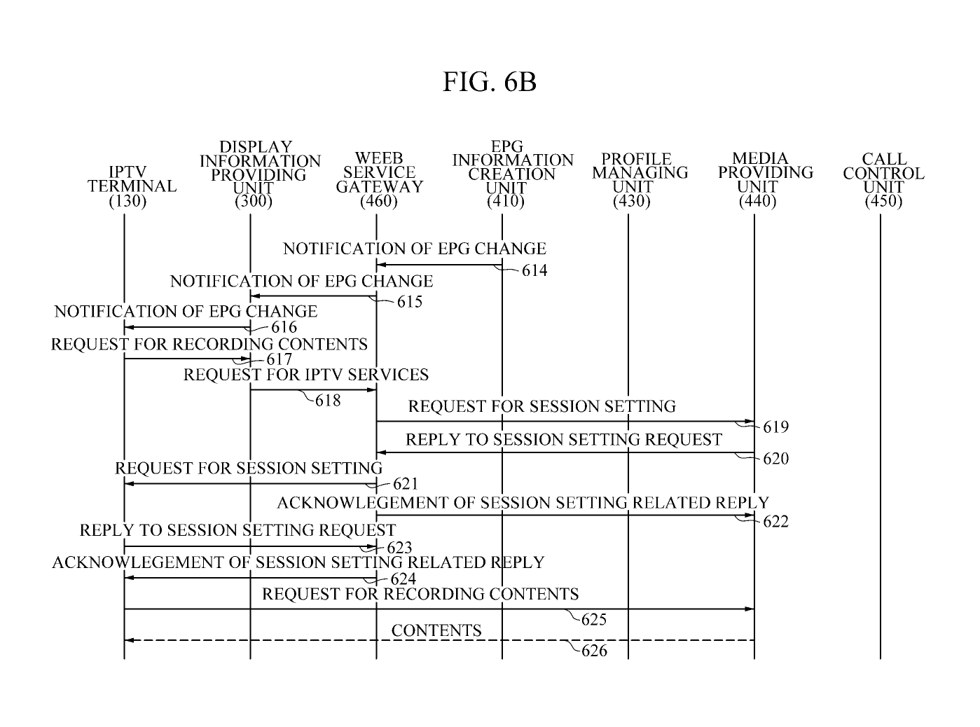

FIGS. 6A and 6B are flowcharts illustrating an example of a method of providing a network-based recording service.

As shown in FIGS. 6A and 6B, a Network Personal Video Recorder (NPVR) service may be provided through the IPTV service control system including the web service gateway 460 and the call control unit 450 for controlling a multimedia session.

Most of channel programs are broadcasted in a manner to transmit preliminary-produced contents according to a program log. Accordingly, the media providing unit 440 having received a request for recording does not record the contents according to a request by each user, but simply stores visual information of the contents requested for recording such that a multimedia stream is transmitted from the stored visual information upon a request for watching the contents.

In addition, in the case of a live broadcast, a live broadcast encoder 470 stores visual information of requested contents while encoding a live broadcast in real time, and transmits a multimedia stream from the stored visual information upon a request for watching recorded content). Hereinafter, a process of providing a Network Personal Video Recorder (NPVR) according to the present invention will be described in detail.

If the IPTV terminal 130 sends the display information providing unit 300 a request message for recording a content (601), the display information providing unit 300 sends the call control unit 450 the corresponding request message through the web service gateway 460 (602 and 603). The call control unit 450 sends the media providing unit 440 the corresponding request message (604) and receives a reply to the request from the media providing unit 440 (605).

After that, the call control unit 450 sends the display information providing unit 300 the reply message to the request through the web service gateway 460 (606 and 607), and the display information providing unit 300 sends the IPTV terminal 130 the corresponding message (608).

Meanwhile, the media providing unit 440, which has performed the request for recording through the call control unit 450, starts recording (609). If the recording is completed, the media providing unit 440 sends the EPG information creation unit 410a notification message on completion of recording, through the profile managing unit 430 (610 and 611). Then, the EPG information creation unit 410 sends the profile managing unit 430 a request for a user profile, and receives a reply to the request for a user profile (612 and 613).

If a change related to EPG information is made, the EPG information creation unit 410 applies the change to EPG information and sends a notification message of the EPG change to the display information providing unit 300 through the web service gateway 460 (614 and 615). The display information providing unit 300 sends the notification message to the IPTV terminal 130 (616). Hereinafter, a process of requesting recorded contents will be described.

If the IPTV terminal 130 sends the display information providing unit 300 a request for recorded contents (617), the display information providing unit 300 sends the web service gateway 460 a request for IPTV services (618). The web service gateway 460 sends the media providing unit 440 a request for session setting (619), and receives a reply to the request for session setting from the media providing unit 440 (620).

The web service gateway 460 sends a request for session setting to the IPTV terminal 130, and sends the media providing unit 440 a session setting related-acknowledge message (621 and 622). In addition, the web service gateway 460 receives a reply to the request for session setting from the IPTV terminal 130 (623).

After that, the web service gateway 460 sends the IPTV terminal 130 a session setting related acknowledge message (624). Then, if the IPTV terminal 130 sends the media providing unit 440 a request for recorded contents, the media providing unit 440 sends the corresponding recorded contents to the IPTV terminal 130. The media providing unit 440 provides a VoD service for the recorded contents based on information about a time at which the request for recording the contents is made.

By providing a user with the VoD service based on information about the recording time, the storage space of the system is efficiently used. In addition, the media providing unit 330 may store message types including a requesting message of recording, a pausing message of recording and a resuming message of recording and a reception time of the above messages and provides a user with a VoD service on the recorded contents.

Each of the components shown throughout FIGS. 1 to 4 may be constituted of ‘modules’. The ‘module’ may be a software component or a hardware component such as Field Programmable Gate Array (FPGA) or Application Specific Integrated Circuit (ASIC), and may implement its own function. The term of “module” is not limited to referring to software or hardware. The “module” may be provided on an addressable storage medium or allow one or more processors to be run. The components and the modules may be provided into smaller number of components and modules such that the respective component and modules may be merged in respect to the functionality. Alternatively, the components and the modules may be provided into larger number of components and modules such that the respective components and modules may be separated in respect to the functionality.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling Internet Protocol television (IPTV) service, the apparatus comprising:
a service control unit configured to conduct a user authentication based on user information of an Internet Protocol television (IPTV) terminal, create Electric Program Guide (EPG) information according to a request for EGP information made by an authorized user, transport the created EPG information to a display information providing unit and provide the IPTV terminal with an IPTV service that is requested using the EPG information by the user,
wherein the display information providing unit processes the EPG information to correspond to an environment of the IPTV terminal based on information about the IPTV terminal and provides the IPTV terminal with the processed EPG information.

2. The apparatus of claim 1, wherein, if a request for a content is made by a user using the EPG information, the service control unit is configured to provide the IPTV terminal with a recorded content based on information about time at which a request for recording the content is made by the user.

3. The apparatus of claim 1, wherein the service control unit comprises:
an authentication unit configured to conduct the user authentication; and
an EPG information creating unit configured to create the EPG information.

4. The apparatus of claim 1, wherein the service control unit further comprises a profile managing unit configured to store information about a user profile, an IPTV terminal profile and a content profile.

5. The apparatus of claim 4, wherein the EPG information creating unit creates the EPG information based on information about a user specific content access right that is included in the user profile.

6. The apparatus of claim 1, wherein the service control unit comprises a live broadcast encoder which is configured to receive a live broadcast and perform encoding in real time; and
a content storage unit configured to store an encoded content.

7. The apparatus of claim 6, wherein the service control unit further comprises a media providing unit which is configured to provide the IPTV terminal with the recorded content based on the information about time at which the request for recording the content is made by the user.

8. The apparatus of claim 7, wherein the service control unit further comprises a call control unit which is configured to control a multimedia session connection between the IPTV terminal and the media providing unit.

9. The apparatus of claim 1, further comprising a web service gateway configured to be associated with the service control unit to mediate at least one operation of a user authentication, an EGP information creation, a request for IPTV services, a session setting, a request for recording, a request for a profile and a change of EPG information.

10. The apparatus of claim 9, wherein the web service gateway comprises:
an IPTV service request handling unit configured to receive at least one message of a request for channel broadcasts, a request for Video on Demand (VoD), a request for Network Personal Video Recorder (NPVR), a request for EPG creation, and a request for session setting and enable the request to be handled through the service control unit; and
an IPTV service request-notification handling unit configured to notify a result of handling the request to the IPTV terminal.

11. The apparatus of claim 9, wherein the web service gateway comprises an authentication access handling unit configured to receive the user information and conduct the user identification through the authentication unit included in the service control unit; and
a profile access handling unit configured to retrieve the profile information through the profile managing unit included in the service control unit.

12. A method of providing an Internet Protocol Television (IPTV) service, the method comprising:
at an authentication unit, conducting a user authentication based on user information of an Internet Protocol Television Service (IPTV) terminal;
at an Electric Program Guide (EPG) information creation unit, creating EPG information based on a user specific content access right that is included in a user profile;
at a display information providing unit, processing the EPG information to correspond to an environment of the IPTV terminal based on information about the IPTV terminal and providing the IPTV terminal with the processed EPG information; and
at a media providing unit, if a request for a content is made by a user using the EPG information, providing the IPTV terminal with a recorded content based on information about time at which the request for recording the content is made by the user.

13. The method of claim 12, wherein
at a call control unit, establishing a multimedia session connection between the IPTV terminal and the media providing unit.

14. The method of claim 13, wherein, at the media providing unit, providing the IPTV terminal with the content after establishing of the multimedia session connection between the IPTV terminal and the media providing unit through the call control unit.

15. The method of claim 14, wherein, at a web service gateway which is associated with the authentication unit, the EPG information creation unit, the display information providing unit, the media providing unit and the call control unit, mediating at least one operation of a user authentication, an EGP information creation, a request for IPTV services, a session setting, a request for recording, a request for a profile and a change of EPG information.

16. The method of claim 12, wherein,. at the EPG information creation unit, if an EPG information related change occurs, applying information of the EPG information related change to the EPG information and transmits a notification message of EGP change to the display information providing unit.
